(19) United States
(12) Patent Application Publication
(10) Pub. No.: US 2025/0289178 A1
(43) Pub. Date: Sep. 18, 2025

(54) STEREOLITHOGRAPHY APPARATUS, AND METHOD OF MANUFACTURING MODELED OBJECT

(71) Applicant: JVCKENWOOD Corporation, Yokohama-shi (JP)

(72) Inventor: Hideki Samata, Yokohama-shi (JP)

(21) Appl. No.: 19/017,867

(22) Filed: Jan. 13, 2025

(30) Foreign Application Priority Data
Mar. 12, 2024 (JP) 2024-038035
Mar. 12, 2024 (JP) 2024-038037

(51) Int. Cl. B29C 64/129; B29C 64/232; B29C 64/245; B29C 64/286; B29C 64/393; B33Y 10/00; B33Y 30/00; B33Y 50/02

(52) U.S. Cl. CPC B29C 64/129; B29C 64/232; B29C 64/245; B29C 64/286; B29C 64/393; B33Y 10/00; B33Y 30/00; B33Y 50/02

(57) ABSTRACT

A stereolithography apparatus including a modeling bath that includes an light transmitting plate on a bottom surface and that stores a photocurable resin and a liquid release material that has a specific gravity larger than that of the photocurable resin and that phase-separates from the photocurable resin; an optical illuminator that applies light that causes the photosensitive resin that is adjusted into a given thickness to cure via the light transmitting plate; a platform that is opposed to an interface between the release material and the photocurable resin and that is capable of lifting or lowering with respect to the interface; and an interface level position adjustment mechanism that adjusts a position of a level of the interface according to a variation in an amount of the release material stored in the modeling bath.

### CROSS-REFERENCE TO RELATED APPLICATIONS

This application claims priority from Japanese Applications No. 2024-038035 and No. 2024-038037, both filed on Mar. 12, 2024, the contents of both of which are incorporated by reference herein in its entirety.

### BACKGROUND OF THE INVENTION

### 1. Field of the Invention

The present disclosure relates to a stereolithography apparatus, a stereolithography control device, and a method of manufacturing a modeled object.

### 2. Description of the Related Art

In general, a stereolithography technique in which light, such as ultraviolet light, is applied to a liquid photocurable resin and a three-dimensional modeled object made of the resin having cured is formed has been known. Japanese Laid-open Patent Publication No. 2020-62841 discloses a stereolithography technique of forming a requested modeled object by layering hardened layers by repeating a step of applying, via a light-transmitting window (light-transmitting portion) that is provided in a bottom surface of a bath in which photocurable resin is stored, light corresponding to a cross-sectional shape of a modeled object in a position of a given level to a base that is arranged such that the base is opposed to the light-transmitting window to model a hardened layer in which the resin cures in the same shape as that of the given cross-sectional surface on a lower surface of the base and a step of lifting the base by a given height with respect to the bath.

In the conventional configuration, because a hardened layer obtained by causing the photocurable to cure is modeled in close contact with the light transmitting window of the bath, an operation of separating the hardened layer from the light transmitting window is necessary each time before the step of lifting the base up with respect to the bath. For this reason, there is a risk that the time required for stereolithography increases and furthermore the modeled object is damaged when separated and thus there is room for improvement in accurate modeling.

According to the conventional configuration, a modeled object is modeled by sequentially layering hardened layers obtained by curing in a direction in which the hardened layers separate from the base. For this reason, in the case where the modeled object has a shape in which part of the modeled object protrudes toward the base and a gap is formed between the protruding portion and the modeled object on the side of the base, sequentially modeling an object including the gap portion from the side of the base and cutting a supporting portion corresponding to the gap portion later are necessary and thus there has been a room for improvement in that the modeling step is complicated.

The present disclosure was made in view of the above-described circumstances and an object of the present disclosure is to provide a stereolithography apparatus enabling both accurate modeling and shortening of the time required for modeling.

The present disclosure was made in view of the above-described circumstances and an object of the present disclosure is to provide a stereolithography apparatus and a method of manufacturing a modeled object that require no modeling of a supporting portion and that make it possible to realize simplification of a modeling step.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

A stereolithography apparatus according to the present disclosure comprising: a modeling bath that includes an light transmitting portion on a bottom surface and that stores a photocurable resin and a liquid release material that has a specific gravity larger than that of the photocurable resin and that phase-separates from the photocurable resin; an optical illuminator that applies light that causes the photosensitive resin that is adjusted into a given thickness to cure via the light transmitting portion; a platform that is opposed to an interface between the release material and the photocurable resin and that is capable of lifting or lowering with respect to the interface; and an interface level position adjustment mechanism that adjusts a position of a level of the interface according to a variation in an amount of the release material stored in the modeling bath.

A method of manufacturing a modeled object according to the present disclosure using a stereolithography apparatus according to the present disclosure that includes a modeling bath that stores a photocurable resin and a liquid release material that has a specific gravity larger than that of the photocurable resin and that phase-separates from the photocurable resin and a platform capable of lifting or lowering with respect to an interface between the release material and the photocurable resin and that models a modeled object by emitting light to the photocurable resin that is adjusted to a given thickness on the interface between the photocurable resin and the release material via the release material and sequentially layering hardened layers in which the photocurable resin cures, the method comprising:
modeling the first modeled object obtained by layering the hardened layers sequentially downward by application of the light while lifting the platform with respect to the interface and after lowering the platform with respect to the interface and sinking at least part of the first modeled object in the release material, modeling the second modeled object obtained by layering the hardened layers sequentially upward by application of the light in a position higher than a lowest surface of the first modeled object while further lowering the platform with respect to the interface.

A method of manufacturing a modeled object according to the present disclosure comprising, storing a photocurable resin and a liquid release material that has a specific gravity larger than that of the photocurable resin and that phase-separates from the photocurable resin in a modeling bath that includes an light transmitting portion on a bottom surface; applying light that causes the photosensitive resin that is adjusted into a given thickness to cure via the light transmitting portion;
opposed to an interface between the release material and the photocurable resin and that is capable of lifting or lowering with respect to the interface; and adjusts a position of a level of the interface according to a variation in an amount of the release material stored in the modeling bath.

### BRIEF DESCRIPTION OF THE DRAWINGS

FIG. 1 is a schematic view illustrating a basic configuration of a stereolithography apparatus according to a first embodiment;

FIG. 2 is a table defining a relationship between determined fineness, a position of a level of an interface, and a distance between a platform and the interface;

FIG. 3 is a schematic view of the stereolithography apparatus in which the interface of a release material is lowered and the distance between the platform and the interface is shortened;

FIG. 4 is a schematic view of the stereolithography apparatus in which the interface of the release material is increased and the distance between the platform and the interface is increased;

FIG. 5 is a schematic view illustrating a basic configuration of a stereolithography apparatus according to a second embodiment;

FIG. 6 is a diagram for describing a procedure of a method of manufacturing a modeled object according to the second embodiment;

FIG. 7 is a diagram for describing the procedure of the method of manufacturing a modeled object according to the second embodiment;

FIG. 8 is a diagram for describing the procedure of the method of manufacturing a modeled object according to the second embodiment;

FIG. 9 is a diagram for describing the procedure of the method of manufacturing a modeled object according to the second embodiment; and

FIG. 10 is a diagram for describing a procedure of a method of manufacturing a modeled object according to a modification.

### DETAILED DESCRIPTION OF THE PREFERRED EMBODIMENTS

Embodiments according to the present disclosure will be described in detail below with reference to the accompanying drawings. Note that the embodiments do not limit the disclosure and, when there are a plurality of embodiments, the embodiments include a configuration obtained by combining each embodiment. In the following embodiments, the same parts are denoted with the same reference numerals and thus redundant description will be omitted.

In the following description of the embodiments, a liquid photocurable resin that does not cure (not hardened) is simply referred to as a photocurable resin unless otherwise specified. A layer of the photocurable resin in a given thickness that is provided between a platform to be described below or a modeled object that is held on the platform and a release material and that is caused to cure by being illuminated with light is referred to as a photocurable resin layer or simply as a resin layer. A stereolithography object that is formed by causing the liquid photocurable resin to cure is referred to as a three-dimensional modeled object or simply as a modeled object. The three-dimensional modeled object is not limited to a finished article obtained by layering all of a plurality of hardened layers formed and includes unfinished object at a stage where hardened layers in the middle are layered.

### First Embodiment

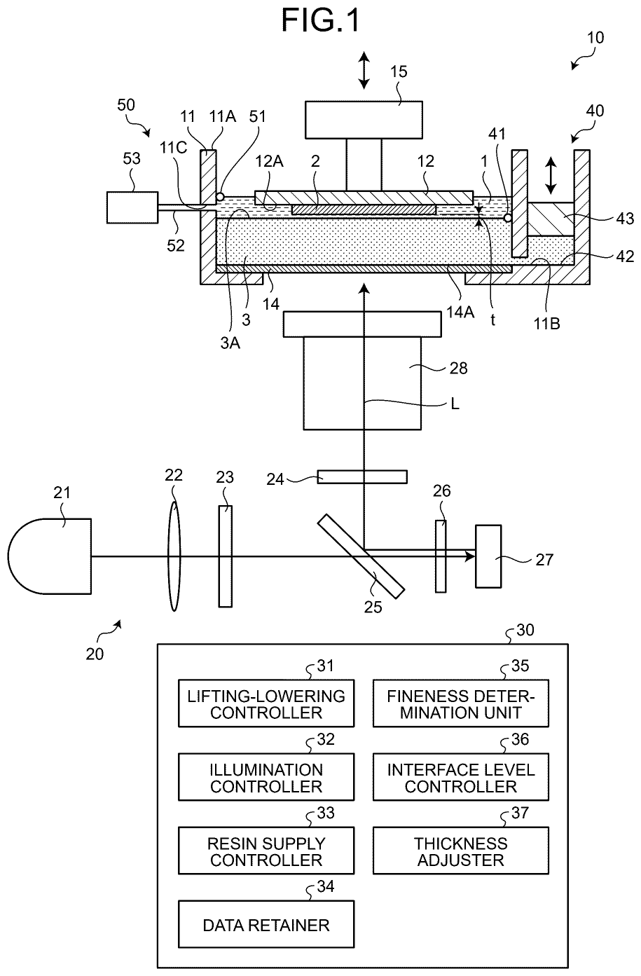

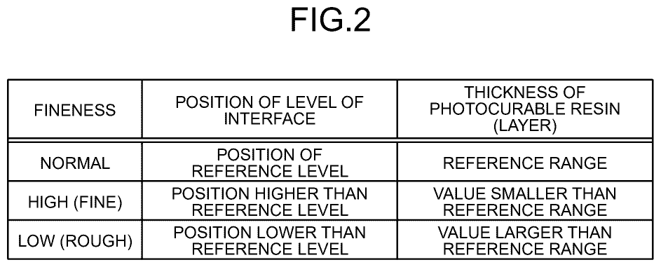

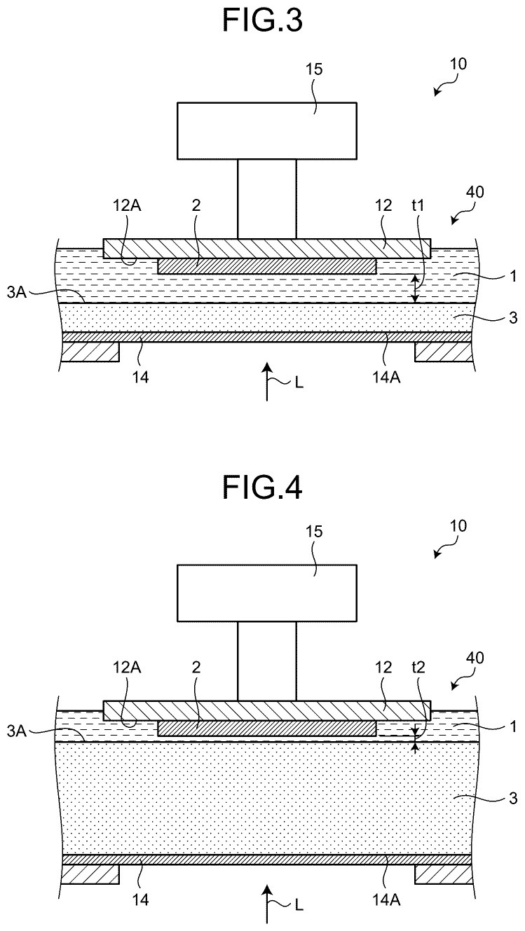

FIG. 1 is a schematic view illustrating a basic configuration of a stereolithography apparatus according to a first embodiment. FIG. 2 is a table defining a relationship between determined fineness, a position of a level of an interface, and a distance between a platform and the interface. FIG. 3 is a schematic view of the stereolithography apparatus in which the interface of a release material is lowered and the distance between the platform and the interface is shortened. FIG. 4 is a schematic view schematic view of the stereolithography apparatus in which the interface of the release material is increased and the distance between the platform and the interface is increased. As illustrated in FIG. 1, a stereolithography apparatus 10 includes a modeling bath 11, a platform 12, an optical illuminator 20, a control device 30, an interface level position adjustment mechanism 40, and a resin supply mechanism 50.

The modeling bath 11 has a plat-like shape with an upper surface being open and is able to store a liquid photocurable resin 1 and a liquid release material 3 that phase-separates from the liquid photocurable resin 1. The modeling bath 11 has a light transmitting plate (light transmitting portion) 14 at a bottom surface. The light transmitting plate 14 transmits light that causes the photocurable resin 1 to cure and an upper surface 14A is formed in a curved shape. This makes it possible to, for example, exert an effect of correcting an aberration that differs at each wavelength with respect to light that is transmitted through the light transmitting plate 14. The light transmitting plate 14 may have the upper surface 14A that is a flat surface.

The photocurable resin 1 is a raw material of the three-dimensional modeled object 2. The photocurable resin 1 is a photocurable fluid resin material that cures with given light (for example, X-rays, ultraviolet rays, or visible light) and, for example, preferably contains three elements of oligomer (for example, epoxy acrylate or urethane acrylate), a reactive diluent (for example, ethylene unsaturated monomer), and a photopolymerization initiator (for example, a benzoin or an acetophenone compound).

The release material 3 is interposed between the light transmitting plate 14 and the photocurable resin 1 and enables the photocurable resin 1 having cured (modeled object 2) to be released (separated) easily. The release material 3 is liquid and is a transparent liquid substance that has a larger specific gravity and a smaller viscosity than those of the photocurable resin 1 and that phase-separates from the photocurable resin 1. The release material 3 preferably is not compatible with the photocurable resin 1 such that the release material 3 phase-separates from the photocurable resin 1 even when the release material 3 and the photocurable resin 1 are stirred and has a clear interface between the release material 3 and the photocurable resin 1. In the first embodiment, because the release material 3 has a specific gravity larger than that of the photocurable resin 1, the release material 3 is stored lowly in the modeling bath 11 and the photocurable resin 1 is stored above the release material 3 as illustrated in FIG. 1. Accordingly, an interface 3A is formed between the release material 3 and the photocurable resin 1. The photocurable resin 1 and a liquid material (for example, saline) inactive to light that causes the photocurable resin 1 to cure are usable as the release material 3.

The release material 3 has characteristics that an amount of the above-described light transmitted through the release material 3 varies according to the height (depth) from the light transmitting plate 14 to the interface 3A between the release material 3 and the photocurable resin 1, that is, the position of the level of the interface 3A between the release material 3 and the photocurable resin 1. For example, a light absorbing agent (a water-soluble light absorbing agent in the first embodiment) that absorbs the above-described light is mixed in the release material 3 and the light absorbing agent absorbs the above-described light effectively. For this reason, changing the position of the level of the interface 3A between the release material 3 and the photocurable resin 1 makes it possible to vary the amount of light transmitted through the release material 3 and increasing the position of the level of the interface 3A reduces the amount of light transmitted and lowering the position of the level of the interface 3A increases the amount of light transmitted.

According to the study of the inventors, it has been proved that, when the amount of light transmitted decreases, excess light is not applied to the photocurable resin 1 and a photocurable resin layer caused to cure has a small thickness, which enables realization of accurate stereolithography. It has been also proved that, when the amount of transmitted light decreases, horizontal modeling can be also accurate. On the other hand, it has been also proved that, when the amount of transmitted light increases, much more light is applied to the photocurable resin 1 and a photocurable resin layer caused to cure has a large thickness, which enables realization of high-speed stereolithography. Adjusting the position of the level of the interface between the release material 3 and the photocurable resin 1 enables both accuracy of the modeled object and high-speed modeling.

The platform 12 holds the modeled object 2 made of the photocurable resin 1 having cured and is opposed to the light transmitting plate 14 and is arranged highly in the modeling bath 11. The platform 12 is formed into a discoid shape or a polygonal platy shape, such as a rectangular platy shape, and is arranged such that a lower surface 12A of the platform 12 is approximately in parallel with the interface 3A between the release material 3 and the photocurable resin 1. The platform 12 is connected to a platform lifting-lowering mechanism 15 and is provided such that the platform 12 is able to lift and lower with respect to the modeling bath 11 according to operations of the platform lifting-lowering mechanism 15. Specifically, the platform 12 is able to get close to or evacuate from the interface 3A and holds the modeled object 2 that is formed on the lower surface 12A that is opposed to the interface 3A.

The optical illuminator 20 is arranged below the modeling bath 11, that is, a side opposite to the platform 12 with the light transmitting plate 14 interposed in between. The optical illuminator 20 applies light L that causes the photocurable resin 1 to cure toward the photocurable resin 1 via the light transmitting plate 14 and the release material 3. The applied light L only need enable the photocurable resin 1 to cure and, for example, ultraviolet rays or a short-wavelength visible light is used. The optical illuminator 20 includes a light source 21, an illuminating lens (illuminating optical system) 22, polarizers 23 and 24, a λ/4 plate 26, and image forming device (light modulation device) 27, a reflective mirror 25, and a projection lens 28.

The light source 21 emits light to be applied to the image forming device 27 and, for example, an ultraviolet lamp, a light emitting diode (LED) lamp, or the like, is used. The illuminating lens 22 is for homogenizing illuminance of light, such as ultraviolet rays, that is emitted from the light source 21. The polarizers 23 and 24 have characteristics in reflecting any one of s-polarization light and p-polarization light and transmitting the other light. The example in FIG. 1 illustrates that the polarizer 23 transmits the P-polarization light and reflects the s-polarization light and the polarizer 24 transmits the s-polarization light and reflects the p-polarization light. The polarizers 23 and 24 are, for example, wire grid polarizers.

The λ/4 plate 26 is a retardation plate that transmits any one of the s-polarization light and the p-polarization light twice at incidence and reflection and thus converts the light to the other. In the example in FIG. 1, the λ/4 plate 26 converts the p-polarization light to the s-polarization light. The image forming device 27 modulates light according to cross-sectional shape data of each layer (in a position of a given level) of the modeled object 2 to be modeled and, for example, a liquid crystal on silicon (LCOS) device, a digital mirror device (DMD), or a liquid crystal device is usable.

The reflective mirror 25 reflects light that is modulated by the image forming device 27 toward the projection lens 28. The reflective mirror 25 reflects anyone of the s-polarization light and the p-polarization light and transmits the other. In the example in FIG. 1, the reflective mirror 25 transmits the p-polarization light and reflects the s-polarization light. The projection lens 28 forms an image of the light that is reflected by the reflective mirror 25.

The interface level position adjustment mechanism 40 adjusts the position of the level of the interface 3A according to a variation in the amount of the release material 3 stored in the modeling bath 11. The position of the level of the interface 3A refers to a position of a level with respect to a given reference position in the modeling bath 11 (for example, the lowest point of the upper surface 14A of the light transmitting plate 14 or a top face 11A of the modeling bath 11). The interface level position adjustment mechanism 40 includes an interface sensor 41 that detects the position of a level of the interface 3A, a reservoir 42 that is connected to the modeling bath 11 via a first through-hole 11B that is formed lowly in the modeling bath 11, and a pressing unit 43 that presses the release material 3 in the reservoir 42.

The interface sensor 41 is provided in an inner wall of the modeling bath 11. The interface sensor 41 detects a position of a level of the interface 3A based on a variance in refractive index, reflectance, conductivity between the photocurable resin 1 and the release material 3. FIG. 1 exemplifies the single interface sensor 41; however, a configuration in which a plurality of interface sensors are arrayed in a height direction may be employed. The reservoir 42 is a portion that temporarily stores the release material 3 that flows from the modeling bath 11 or flows into the modeling bath 11 via the first through-hole 11B. The pressing unit 43 is arranged slidably in the height direction via an airtight member (packing) between the pressing unit 43 and the inner wall of the reservoir 42. For example, a space in the reservoir 42 above the pressing unit 43 is closed up and the pressure (barometric pressure) in this upper space is increased and the pressing unit 43 is pushed down, the release material 3 in the reservoir 42 flows into the modeling bath 11 via the first through-hole 11B and accordingly the position of the level of the interface 3A between the release material 3 and the photocurable resin 1 in the modeling bath 11 increases. When the pressure (barometric pressure) in the upper space is lowered (for example, is lowered to an atmospheric pressure or lower) and the pressing unit 43 is raised, the release material 3 in the modeling bath 11 flows into the reservoir 42 via the first through-hole 11B and accordingly the position of the level of the interface 3A between the release material 3 and the photocurable resin 1 in the modeling bath 11 lowers. Note that an existing technique is applicable to a mechanism that causes the pressing unit 43 to lift and lower with respect to the reservoir 42.

The resin supply mechanism 50 supplies the photocurable resin 1 to the modeling bath 11. In the first embodiment, the resin supply mechanism 50 includes a level sensor 51 that detects a fluid level of the photocurable resin 1 stored in the modeling bath 11, a supply pipe 52 that is connected to the modeling bath 11 via a second through-hole 11C that is formed in the modeling bath 11, and a resin supply pump 53 that is joined to the supply pipe 52.

The level sensor 51 is a sensor that detects whether a given amount of the photocurable resin 1 is stored in the modeling bath 11 and is provided in an inner wall of the modeling bath 11 above the second through-hole 11C. The second through-hole 11C serves as a port via which the photocurable resin 1 is supplied to the modeling bath 11 and is preferably formed in a position higher than an upper-limit setting position of the interface 3A of the release material 3. The resin supply pump 53 is, for example, a quantitative pump in which it is possible to set a supply (an amount of ejection) of the photocurable resin 1 per unit of time. The resin supply pump 53 stops supplying the photocurable resin 1, for example, when the level sensor 51 detects the fluid level of the photocurable resin 1.

In the first embodiment, the stereolithography apparatus 10 includes the modeling bath 11 that stores the photocurable resin 1 and the liquid release material 3 that has a specific gravity larger than that of the photocurable resin 1 and that phase-separates from the photocurable resin 1 and the platform 12 that is opposed to the interface 3A between the release material 3 and the photocurable resin 1 and that is capable of lifting or lowering with respect to the interface 3A and executes stereolithography by applying light to the photocurable resin 1 via the release material 3. Specifically, in the stereolithography apparatus 10, as illustrated in FIG. 1, a photocurable resin layer that is made of the photocurable resin 1 and that has a given thickness t is formed between the platform 12 or the modeled object 2 and the interface 3A and light of a given cross-sectional shape that is modulated by the image forming device 27 is applied to the photocurable resin layer. The given thickness t is set at a thickness (for example, approximately few um to 100 μm) of one hardened layer to be formed. In this configuration, because the photocurable resin layer in the given thickness t is caused to cure on the release material 3 that phase separates from the photocurable resin layer, the hardened layer after curing and the release material 3 are never in close contact with each other. For this reason, lifting the platform 12 by the same distance as the given thickness t makes it possible to form each photocurable resin layer having the given thickness t again between the platform 12 or the modeled object 2 and the interface 3A. As described above, in the first embodiment, because the photocurable resin is prevented from being in close contact with the light transmitting plate of the modeling bath when the photocurable resin cures, an operation of separating the hardened layer from the light transmitting plate each time is unnecessary. Accordingly, it is possible to shorten the time required for stereolithography and prevent a modeled object from being damaged when separated, which enables realization of both accurate modeling and shortening of the time required for modeling.

In the first embodiment, the stereolithography apparatus 10 has the liquid release material 3 that phase-separates from the photocurable resin 1 and that is interposed between the light transmitting plate 14 and the photocurable resin 1. For this reason, the upper surface 14A of the light transmitting plate 14 need not be flat and the upper surface 14A is formed in a curved shape having a given optical effect. Specifically, it is possible to employ a configuration in which the upper surface 14A of the light transmitting plate 14 is curved to impart a lens function and, for example, exert an effect of correcting an aberration that differs according to each wavelength on the applied light.

The control device 30 is an arithmetic processing unit configured of a central processing unit (CPU), or the like, is connected to each unit of the stereolithography apparatus 10, and controls the functions of the units. The control device 30 stores a program on a method of manufacturing the modeled object 2 and loads the program into a memory and executes instructions contained in the program. The control device 30 includes an internal memory not illustrated in the drawings and the internal memory is used to temporarily store data of the program, etc., in the control device 30.

The control device 30 includes a lifting-lowering controller 31, an illumination controller 32, a resin supply controller 33, a data retainer 34, a fineness determination unit 35, an interface level controller 36, and a thickness adjuster 37. The lifting-lowering controller 31 controls the position of the level of the platform 12 by controlling operations of the platform lifting-lowering mechanism 15. Specifically, based on the result of an adjustment made by the thickness adjuster 37, the lifting-lowering controller 31 causes the platform 12 to lift and lower, thereby forming a photocurable resin layer that is adjusted to have the given thickness t between the platform 12 or the modeled object 2 and the interface 3A.

The illumination controller 32 calculates an optical illumination pattern representing a cross-sectional shape of the modeled object 2 in each position of a given level based on three-dimensional shape data and controls the light source 21, the image forming device 27, etc., thereby applying light to the photocurable resin. For this reason, by applying light corresponding to the cross-sectional shape of each layer (in the position of the given level) of the modeled object 2 to the photo-curable resin layer between the modeled object 2 and the interface 3A, the illumination controller 32 is able to form a hardened layer having a given thickness.

The resin supply controller 33 controls operations of supplying the photocurable resin 1 to the modeling bath 11. Specifically, the resin supply controller 33 controls the supply of the photocurable resin 1 by controlling operations of the resin supply pump 53 based on a result of detection by the level sensor 51. For example, when the level sensor 51 detects a level of the photocurable resin 1, the resin supply controller 33 stops operations of the resin supply pump 53 and thereby stops supplying the photocurable resin 1.

The data retainer 34 retains design image data defining each cross-sectional shape of each layer (in each position of a given level) in formation of the objective modeled object 2. When the objective modeled object 2 is formed of k layers (k is a natural number), the data retainer 34 retains design image data defining cross-sectional shapes of all the respective layers from the first layer to the k-th layer.

The fineness determination unit 35 determines fineness (detail) of a cross-sectional shape of a layer to be modeled based on the design image data that the data retainer 34 retains. The fineness refers to a minimum design size of the design image data on the cross-sectional shape of a layer (the position of the level) to be modeled in a horizontal direction. The fineness determination unit 35 determines that the fineness is normal when the minimum design size is within a given reference range (for example, between 500 μm and 1000 μm inclusive). The fineness determination unit 35 determines that the fineness is high (fine) when the minimum design size is a value smaller than the above-described given reference range. The fineness determination unit 35 determines that the fineness is low (rough) when the minimum design size is a value larger than the given reference range. The exemplified reference range is an example and the reference range may be changed as appropriate according to the objective modeled object 2. In the first embodiment, fineness is generally divided into three stages of normal, high, and low, and the fineness may be divided more.

The interface level controller 36 controls operations of the interface level position adjustment mechanism 40 according to the fineness that is determined by the fineness determination unit 35 and thereby adjusts the position of the level of the interface 3A using the variation in the amount of the release material 3 stored in the modeling bath 11. Specifically, when it is determined that the fineness is normal, the interface level controller 36 adjusts the position of the level of the interface 3A to a reference level position. The reference level position is set, for example, such that the amount of light transmitted through the release material 3 is within a reference range. The interface level controller 36 adjusts the position of the level of the interface 3A to a position higher than the reference level position when it is determined that the fineness is high and adjusts the position of the level of the interface 3A to a position lower than the reference level position when it is determined that the fineness is low. The first embodiment employs the configuration in which table data like that illustrated in FIG. 2 is retained by the data retainer 34 and the interface level controller 36 acquires data on the position of the level of the interface 3A from the table data according to the fineness that is determined by the fineness determination unit 35; however, the interface level controller 36 may calculate data on the position of the height each time.

The thickness adjuster 37 adjusts the thickness of the photocurable resin 1 between the interface 3A of the release material 3 and the platform 12 or the modeled object 2 according to the fineness determined by the fineness determination unit 35. In this case, an adjustment on the position of the level of the interface 3A described above leads to an adjustment to a thickness on which the effect of optical energy of the optical illuminator 20 is reduced with respect to layers to be modeled from now. Specifically, when it is determined that the fineness is normal, the thickness adjuster 37 makes an adjustment such that the thickness of the photocurable resin 1 is within a given reference range (for example, between 50 μm and 100 μm inclusive). The thickness adjuster 37 adjusts the thickness of the photocurable resin 1 to a value (for example, 25 μm) smaller than the reference range when it is determined that the fineness is high and adjusts the thickness of the photocurable resin 1 to a value (for example, 200 μm) larger than the reference range when it is determined that the fineness is low. This case also employs the configuration in which table data like that illustrated in FIG. 2 is retained by the data retainer 34 and the thickness adjuster 37 acquires data on the thickness of the photocurable resin 1 from the table data according to the fineness that is determined by the fineness determination unit 35; however, the thickness adjuster 37 may calculate a thickness of the photocurable resin 1 each time. In the first embodiment, the lifting-lowering controller 31 adjusts the distance between the platform 12 and the interface 3A based on the result of the adjustment made by the thickness adjuster 37.

As described above, in the first embodiment, when the fineness of the cross-sectional shape of a layer to be modeled is low, the stereolithography apparatus 10 adjusts the position of the level of the interface 3A between the release material 3 and the photocurable resin 1 to a position lower than the reference level position and makes an adjustment on the distance between the platform 12 and the interface 3A such that the thickness of the photocurable resin 1 is a value (t1) larger than the reference range as illustrated in FIG. 3. According to this configuration, because the photocurable resin 1 that is adjusted to be thick by increasing the amount of light transmitted through the release material 3 can be caused to cure efficiently, for example, it is possible to model a portion whose fineness is low at high speed.

When the fineness of the cross-sectional shape of a layer to be modeled is high, the position of the level of the interface 3A between the release material 3 and the photocurable resin 1 is adjusted to a position higher than the reference level position and an adjustment is made on the distance between the platform 12 and the interface 3A such that the thickness of the photocurable resin 1 is a value (t2) smaller than the reference range. According to this configuration, because the amount of light transmitted through the release material 3 is reduced and excess light does not reach the photocurable resin 1, the photocurable resin 1 that is adjusted to be thin can be caused to cure accurately and accordingly, for example, it is possible to model a portion with high fineness accurately. Thus, combining these types of modeling according to the above-described fineness makes it possible to effectively realize both accurate modeling and shortening of the time required for modeling.

The stereolithography apparatus 10 according to the first embodiment includes the modeling bath 11 that includes the light transmitting plate 14 at a bottom surface and that stores the photocurable resin 1 and the liquid release material 3 that has a specific gravity larger than that of the photocurable resin 1 and that phase-separates from the photocurable resin 1; the optical illuminator 20 that applies light that causes the photocurable resin 1 that is adjusted to have a given thickness to cure via the light transmitting plate 14; the platform 12 that is opposed to the interface 3A between the release material 3 and the photocurable resin 1 and that is capable of lifting or lowering with respect to the interface 3A; and the interface level position adjustment mechanism 40 that adjusts the position of the level of the interface 3A according to a variation in the amount of the release material 3 stored in the modeling bath 11. According to this configuration, because the interface level position adjustment mechanism 40 adjusts the position of the level of the interface 3A accurately and accordingly it is possible to control the position of the platform 12 with respect to the interface 3A accurately, it is possible to adjust the thickness of the photocurable resin 1 positioned on the interface 3A accurately and model the modeled object 2 accurately. Furthermore, because the release material 3 is interposed between the photocurable resin 1 and the light transmitting plate 14, the photocurable resin 1 is prevented from being in close contact with the light transmitting plate 14 when the photocurable resin 1 cures, an operation of separating the hardened layer in which the photocurable resin 1 cures each time before the platform 12 is lifted is unnecessary. Accordingly, it is possible to shorten the time required for stereolithography and prevent a modeled object from being damaged when separated, which makes it possible to realize both accurate modeling and shortening the time required for modeling.

The upper surface 14A of the light transmitting plate 14 on a side opposed to the release material 3 is formed into a curved shape having a given optical effect and therefore, for example, it is possible to correct an aberration that differs at each wavelength with respect to light that is transmitted through the light transmitting plate 14.

The release material 3 has characteristics that an amount of light that is transmitted through the release material 3 varies according to the position of the level of the interface 3A, the fineness determination unit 35 (the control device 30) that determines fineness of a cross-sectional shape in a position of a level to be modeled based on the design image data that defines a cross-sectional shape in a position of each given level of the modeled object 2 that is modeled by application of light is included, and the interface level position adjustment mechanism 40 adjusts the position of the level of the interface 3A according to the determined fineness. According to this configuration, the position of the level of the interface 3A is adjusted according to the determined fineness and accordingly the amount of light transmitted through the release material 3 varies. For this reason, for example, when the fineness is high, it is possible to model a portion with high fineness accurately by increasing the position of the level of the interface 3A and reducing the thickness of the photocurable resin 1. For example, when the fineness is low, lowering the position of the level of the interface 3A and increasing the thickness of the photocurable resin 1 enables an increase in the amount of modeling (thickness of the modeled object) per unit of time, which makes it possible to realize high-speed modeling. It is thus possible to enable both accuracy of the modeled object and high-speed modeling.

The interface level position adjustment mechanism 40 adjusts the position of the level of the interface 3A to a position higher than a given reference level when it is determined that the fineness is high and adjusts the position of the level of the interface to a position lower than the given reference level when it is determined that the fineness is low, which makes it possible to appropriately adjust the amount of light transmitted through the photocurable resin 1 via the release material 3.

The platform 12 adjusts the thickness of the photocurable resin 1 to a value smaller than a given reference range when it is determined that the fineness is high and adjusts the thickness to a value higher than the given reference range when it is determined that the fineness is low, which makes it possible to adjust the thickness of the photocurable resin 1 to an appropriate value that matches the amount of light transmitted.

### Second Embodiment

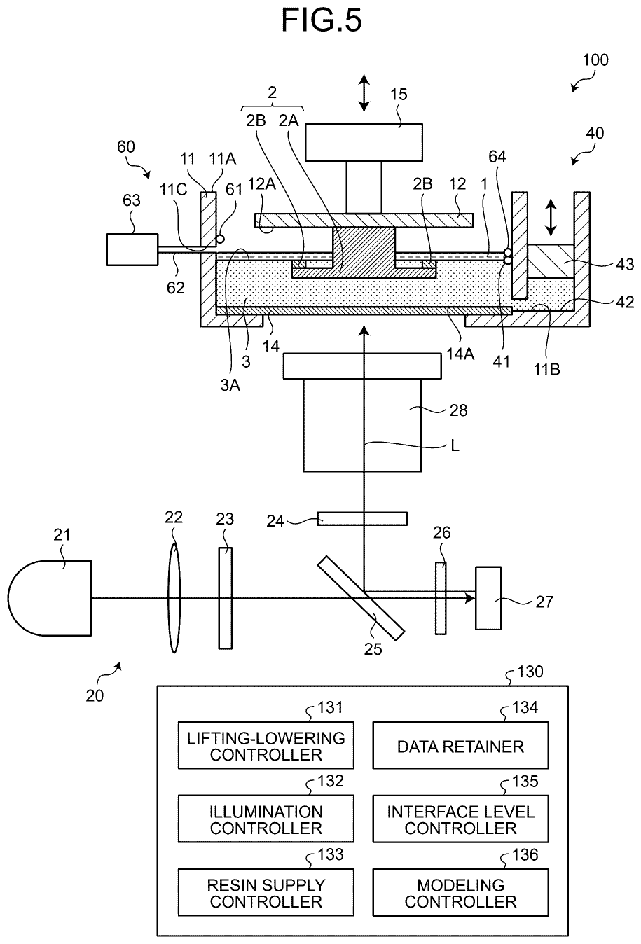

A stereolithography apparatus according to a second embodiment will be described next. FIG. 5 is a schematic view illustrating a basic configuration of the stereolithography apparatus according to the second embodiment. The same components as those of the above-described first embodiment are denoted with the same reference numerals and description thereof will be omitted.

In the stereolithography apparatus of the first embodiment, because the release material 3 is interposed between the photocurable resin 1 and the light transmitting plate 14, the operation of separating a hardened layer in which the photocurable resin 1 cures from the light transmitting plate 14 is unnecessary and it is possible to shorten the time required for stereolithography and prevent a modeled object from being damaged when separated. On the other hand, for example, when part of the modeled object protrudes toward the platform 12 and a gap is formed between the protruding portion and the modeled object on the side of the platform 12, it is conventionally necessary to sequentially model an object including the gap portion from the side of the platform 12 and cut a supporting portion corresponding to the gap portion later and thus a problem that a modeling step becomes complicated is assumed.

Thus, in the second embodiment, a stereolithography apparatus 100 models the modeled object 2 including a first modeled object 2A that is modeled from the platform 12 downward and a second modeled object 2B that protrudes up toward the platform 12 in a position higher than a lowest surface of the first modeled object 2A in a simple step without cutting a supporting portion. As illustrated in FIG. 5, the stereolithography apparatus 100 includes the modeling bath 11, the platform 12, the optical illuminator 20, a control device (stereolithography control device) 130, the interface level position adjustment mechanism 40, and a resin supply mechanism 60.

The interface level position adjustment mechanism 40 has the same configuration as that of the first embodiment; however, the second embodiment is different in that the position of a given level is maintained without varying the position of the level of the interface 3A. In the second embodiment, because part of the modeled object 2 sinks in the release material 3 when the second modeled object 2B is modeled, the position of the level of the interface 3A of the release material 3 varies slightly because of the volume of the sinking modeled object 2. For this reason, in the interface level position adjustment mechanism 40, operations of the pressing unit 43 are controlled based on the result of detection by the interface sensor 41 such that the interface 3A maintains the position of a certain level.

The resin supply mechanism 60 supplies the photocurable resin 1 to the modeling bath 11 as in the first embodiment. In the second embodiment, the resin supply mechanism 60 includes a first level sensor 61 that detects a fluid level of the photocurable resin 1 stored in the modeling bath 11, a supply pipe 62 that is connected to the modeling bath 11 via the second through-hole 11C that is formed in the modeling bath 11, a resin supply-discharge pump 63 that is joined to the supply pipe 62, and a second level sensor 64 that is provided in a position lower than that of the first level sensor 61 and that detects a fluid level of the photocurable resin 1.

As the level sensor 51 of the first embodiment does, the first level sensor 61 is a sensor that detects whether a given amount of the photocurable resin 1 is stored in the modeling bath 11. In the second embodiment, the first level sensor 61 is used to control the level of the photocurable resin 1 in the modeling bath 11 in modeling the first modeled object 2A by what is referred to as a regulated level system.

The second level sensor 64 is a sensor that detects whether a given amount of the photocurable resin 1 is stored in the modeling bath 11. Specifically, the second level sensor 64 is provided in a position higher than the position of the level of the above-described interface 3A by a given thickness (a thickness of one of one hardened layer to be formed, for example, approximately few μm to 100 μm). In the second embodiment, the second level sensor 64 is used to control the level of the photocurable resin 1 in the modeling bath 11 in modeling the second modeled object 2B by what is referred to as a free level system.

The resin supply-discharge pump 63 is a pump having a function of, while supplying the photocurable resin 1 to the modeling bath 11, discharging the excess photocurable resin 1 from the modeling bath 11. In this case, a configuration including a supply pump and a discharge pump separately may be employed. For example, when the first level sensor 61 detects a fluid level of the photocurable resin 1 when the first modeled object 2A is modeled, the resin supply-discharge pump 63 stops supplying the photocurable resin 1 For example, when the second modeled object 2B is modeled, the resin supply-discharge pump 63 supplies or discharges the photocurable resin 1 according to a result of detecting by the second level sensor 64 and operates such that the fluid level of the photocurable resin 1 is with the given thickness t with respect to the position of the level of the interface 3A.

As the above-described control device 30 is, a control device 130 is, for example, an arithmetic processing unit configured of a central processing unit (CPU), or the like, is connected to each unit of the stereolithography apparatus 100, and controls the functions of the units. The control device 130 stores a program on a method of manufacturing the modeled object 2 (the first modeled object 2A and the second modeled object 2B) and loads the program into a memory and executes instructions contained in the program. The control device 130 includes an internal memory not illustrated in the drawings and the internal memory is used to temporarily store data of the program, etc., in the control device 130.

The control device 130 includes a lifting-lowering controller 131, an illumination controller 132, a resin supply controller 133, a data retainer 134, an interface level controller 135, and a modeling controller 136. The lifting-lowering controller 131 controls the position of the level of the platform 12 by controlling operations of the platform lifting-lowering mechanism 15. Specifically, when the first modeled object 2A is modeled, the lifting-lowering controller 131 causes the platform 12 to lift and lower, thereby forming a photocurable resin layer that is adjusted to have the given thickness t between the platform 12 or the modeled object 2 and the interface 3A. When the second modeled object 2B is modeled, the lifting-lowering controller 131 causes the platform 12 to lower such that part of the modeled object 2 being modeled is sunk in the release material 3 and, for example, a surface on which the second modeled object 2B is modeled is brought in line with the interface 3A of the release material 3 and a photocurable resin layer adjusted to the given thickness t is formed on the interface 3A.

The illumination controller 132 calculates an optical illumination pattern representing a cross-sectional shape of the modeled object 2 (the first modeled object 2A and the second modeled object 2B) in each position of a given level based on three-dimensional shape data and controls the light source 21, the image forming device 27, etc., thereby applying light to the photocurable resin. For this reason, by applying light corresponding to the cross-sectional shape of each layer (in the position of the given level) of the modeled object 2 to the photo-curable resin layer that is adjusted to a given thickness, the illumination controller 132 is able to form a hardened layer having a given thickness.

The resin supply controller 133 controls operations of supplying or discharging the photocurable resin 1 to or from the modeling bath 11. Specifically, when the first modeled object 2A is modeled, the resin supply controller 133 controls the supply of the photocurable resin 1 by controlling operations of the resin supply-discharge pump 63 based on a result of detection by the first level sensor 61. For example, when the first level sensor 61 detects a level of the photocurable resin 1, the resin supply controller 133 stops operations of the resin supply-discharge pump 63 and thereby stops supplying the photocurable resin 1. When the second modeled object 2B is modeled, the resin supply controller 133 supplies or discharges the photocurable resin 1 by controlling the operations of the resin supply-discharge pump 63 based on a result of detection by the second level sensor 64 and makes an adjustment such that the fluid level of the photocurable resin 1 is at the given thickness t with respect to the position of the level of the interface 3A.

The data retainer 134 retains design image data defining each cross-sectional shape of each layer (in each position of a given level) in formation of the objective modeled object 2 (the first modeled object 2A and the second modeled object 2B). When the objective modeled object 2 is formed of k layers (k is a natural number), the data retainer 34 retains design image data defining cross-sectional shapes of all the respective layers from the first layer to the k-th layer.

The interface level controller 135 controls operations of the interface level position adjustment mechanism 40 and thereby makes an adjustment to maintain the position of the level of the interface 3A constant using a variation in the amount of the release material 3 stored in the modeling bath 11. Specifically, when the first modeled object 2A is modeled, the interface level controller 36 controls operations of the pressing unit 43 based on the result of detection by the interface sensor 41 such that the interface 3A maintains the position of a certain level. When the second modeled object 2B is modeled, part of the modeled object 2 sinks in the release material 3 and accordingly the position of the level of the interface 3A of the release material 3 varies slightly because of the volume of the sinking modeled object 2. For this reason, the interface level controller 36 controls operations of the pressing unit 43 based on the result of detection by the interface sensor 41 such that the interface 3A maintains the position of a certain level.

The modeling controller 136 controls the lifting-lowering controller 131, the illumination controller 132, the resin supply controller 133, the data retainer 134, and the interface level controller 135 and controls general modeling operations of the stereolithography apparatus 100. Specifically, the modeling controller 136 causes the stereolithography apparatus 100 to execute an operation of modeling the first modeled object 2A obtained by layering hardened layers sequentially downward by application of light while lifting the platform 12 with respect to the interface 3A and an operation of, after lowering the platform 12 with respect to the interface 3A and sinking at least part of the first modeled object 2A in the release material, modeling the second modeled object 2B obtained by layering hardened layers sequentially upward by application of light in a position higher than a lowest surface of the first modeled object 2A while further lowering the platform 12 with respect to the interface 3A.

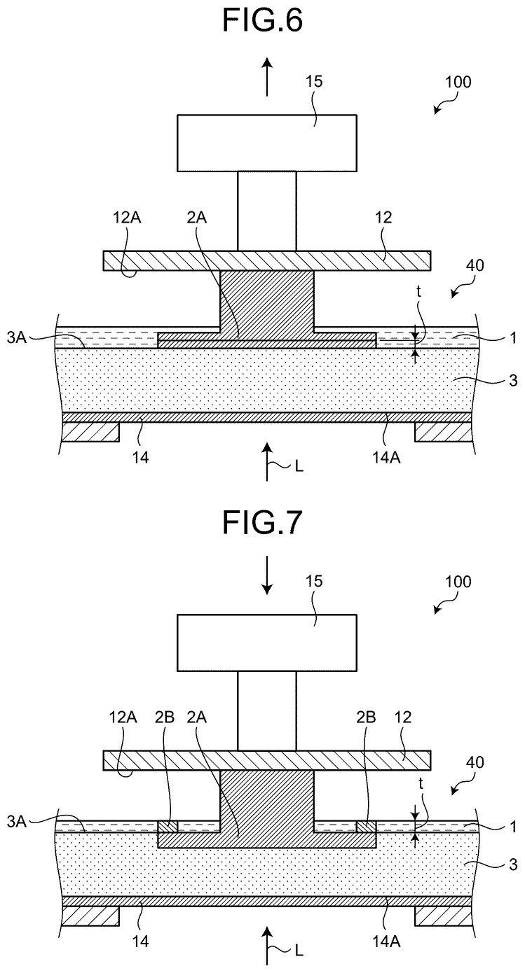

With reference to FIGS. 6 to 9, a method of manufacturing a modeled object according to the second embodiment will be described next. These drawings schematically illustrates part of the stereolithography apparatus 100 illustrated in FIG. 5. First, the first modeled object 2A is modeled. When the first modeled object 2A is modeled, the modeling controller 136 controls operations of the pressing unit 43 by the interface level controller 36 and the interface 3A maintains the position of the constant level based on a result of detection by the interface sensor 41. The modeling controller 136 also controls operations of the resin supply-discharge pump 63 by the resin supply controller 133 and supplies the photocurable resin 1 to the modeling bath 11 until the first level sensor 61 detects a fluid level of the photocurable resin 1. As illustrated in FIG. 6, the modeling controller 136 lifts the platform 12 by the lifting-lowering controller 131 and arranges the platform 12 in a position such that the lowest surface of the first modeled object 2A that is held by the platform and that is being modeled and the interface 3A of the release material 3 have a given distance t in between. In this case, a photocurable resin layer having a given thickness t equal to the given distance t is formed between the lowest surface of the first modeled object 2A and the interface 3A of the release material 3.

Subsequently, by the illumination controller 132, the modeling controller 136 calculates an illumination pattern representing a cross-sectional shape of the first modeled object 2A at a given level based on the three-dimensional data on the objective first modeled object 2A and applies light L corresponding to the cross-sectional shape of a layer (the k-th layer) of the objective level to the photocurable resin layer via the light transmitting plate 14. Accordingly, the photocurable resin layer cures into the same shape as the cross-sectional shape of the k-th layer. Thus, as illustrated in FIG. 6, a hardened layer having the given thickness t is further formed on the lowest surface of the first modeled object 2A.

The modeling controller 136 repeatedly executes the above-described procedure until modeling of the last layer of the first modeled object 2A ends and completes the first modeled object 2A. Subsequently, the second modeled object 2B is modeled.

As illustrated in FIG. 7, by the lifting-lowering controller 131, the modeling controller 136 lowers the platform 12 and sinks part of the first modeled object 2A that is held by the platform 12 in the release material 3 and accordingly a surface of the first modeled object 2A on which the second modeled object 2B is to be modeled is arranged in a position that matches the interface 3A of the release material 3. By the resin supply controller 133, the modeling controller 136 controls operations of the resin supply-discharge pump 63 based on a result of detection by the second level sensor 64, supply or discharges the photocurable resin 1, and makes an adjustment such that the fluid level of the photocurable resin 1 is with the given thickness t with respect to the position of the level of the interface 3A. In this manner, a photocurable resin layer that is adjusted to the given thickness t is formed on the surface of the first modeled object 2A on which the second modeled object 2B is to be modeled.

Subsequently, by the illumination controller 132, the modeling controller 136 calculates an illumination pattern representing a cross-sectional shape of the second modeled object 2B at a given level based on the three-dimensional shape data on the objective second modeled object 2B and applies light L corresponding to the cross-sectional shape of a layer of an objective level (for example, the first layer) to the photocurable resin layer via the light transmitting plate 14. The light L is transmitted through the first modeled object 2A and the photocurable resin layer cures in the same shape as the cross-sectional shape of the first layer. Accordingly, as illustrated in FIG. 7, a hardened layer having the given thickness t is formed on the surface of the first modeled object 2A on which modeling is performed.

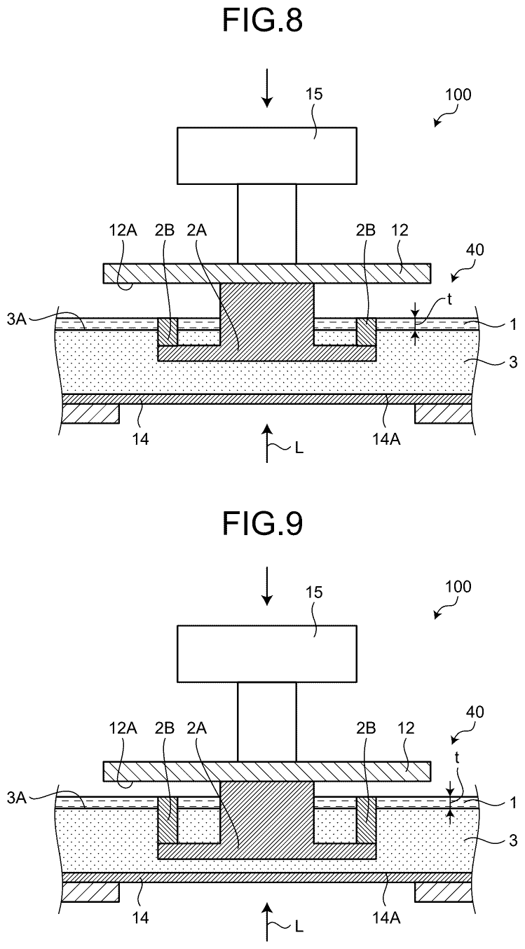

As illustrated in FIG. 8 and FIG. 9, the modeling controller 136 repeatedly executes the above-described procedure until modeling of the last layer of the second modeled object 2B ends and completes the second modeled object 2B (modeled object 2). According to this configuration, even when part of the second modeled object 2 protrudes toward the platform 12 and a gap is formed between the protruding portion and the modeled object 2 (the first modeled object 2A) on the side of the platform 12 as in the second modeled object 2B, it is unnecessary to model a supporting portion corresponding to the gap portion together and cut the supporting portion later as conventionally. It is thus possible to realize simplification of the modeling step.

According to the second embodiment, the stereolithography control device that controls the stereolithography apparatus 100 that includes the modeling bath 11 that stores the photocurable resin 1 and the liquid release material 3 that has a specific gravity larger than that of the photocurable resin 1 and that phase-separates from the photocurable resin 1 and the platform 12 capable of lifting or lowering with respect to the interface 3A between the release material 3 and the photocurable resin 1 and that models the modeled object 2 by emitting the light L to the photocurable resin 1 that is adjusted to the given thickness t on the interface 3A between the photocurable resin 1 and the release material 3 via the release material 3 and sequentially layering hardened layers in which the photocurable resin 1 cures, the stereolithography control device 130 including the modeling controller 136 that executes a step of modeling the first modeled object 2A obtained by layering hardened layers sequentially downward by application of light while lifting the platform 12 with respect to the interface 3A and a step of, after lowering the platform 12 with respect to the interface 3A and sinking at least part of the first modeled object 2A in the release material 3, uniformly modeling the second modeled object 2B obtained by layering hardened layers sequentially upward by application of the light L in a position higher than a lowest surface of the first modeled object 2A while further lowering the platform 12 with respect to the interface 3A. According to this configuration, even when part of the second modeled object 2 is in a position higher than the lowest surface of the first modeled object 2A and a gap is formed between the portion and the modeled object 2 (the first modeled object 2A) on the side of the platform 12, it is unnecessary to model a supporting portion corresponding to the gap portion together and cut the supporting portion later as conventionally. It is thus possible to realize simplification of the modeling step.

The modeling controller 136 models the second modeled object 2B from the surface of the first modeled object 2A on which modeling is performed and that is positioned on the side of the platform 12 toward the platform 12 and therefore, even when part of the second modeled object 2 protrudes toward the platform 12 and a gap is formed between the protruding portion and the modeled object 2 (the first modeled object 2A) on the side of the platform 12 as in the second modeled object 2B, it is unnecessary to model a supporting portion corresponding to the gap portion together and cut the supporting portion later as conventionally. It is thus possible to realize simplification of the modeling step.

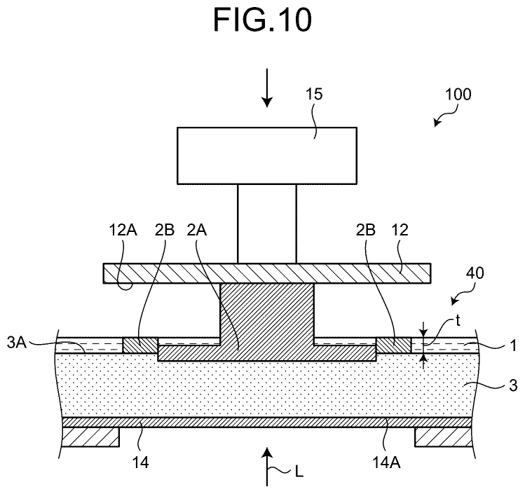

In the second embodiment, the procedure for modeling the modeled object 2 having the shape partly protruding toward the platform 12 has been described; however, the procedure is not limited to this. For example, as illustrated in FIG. 10, the modeling controller 136 may be configured to uniformly model the second modeled object on a surface of the first modeled object 2A along a height direction. This configuration, for example, makes it possible to easily change the shape of a modeled object in the middle of modeling.

In the second embodiment, the first modeled object 2A and the second modeled object 2B are modeled using the same photocurable resin 1; however, the first modeled object 2A and the second modeled object 2B may be modeled using different photocurable resins. Specifically, the modeling controller 136 executes a step of making a replacement with a photocurable resin of a type different from that of the photocurable resin 1 corresponding to the first modeled object 2A after the step of modeling the first modeled object 2A and the second modeled object 2B is modeled using the different photocurable resin. According to this configuration, using a photocurable resin that cures with light with a different wavelength leads to a variation of the modeled object 2. Furthermore, selecting a wavelength that is absorbed less easily by the first modeled object 2A as the different wavelength makes it possible to solve the problem that the amount of light transmitted varies because of a difference in the thickness of the first modeled object 2A.

The stereolithography apparatuses 10 and 100 and the control devices 30 and 130 according to the disclosure have been described and the disclosure may be carried out in various different modes in addition to the above-described embodiments. Note that each component of the stereolithography apparatuses and the control devices illustrated in the drawings is a functional idea and need not necessarily be configured physically as illustrated in the drawings. In other words, specific modes of each device are not limited to those illustrated in the drawings and all or part of the device may be functionally or physically distributed or integrated in any unit according to the processing load and usage of each device.

The configurations of the control devices 30 and 130, for example, are implemented by a program that is loaded into a memory, or the like, as software. In the above-described embodiment, they have been described as functional blocks that are realized by cooperation of hardware or software thereof. In other words, these functional blocks can be realized in various forms by only hardware, only software or a combination of hardware and software.

According to the present disclosure, an effect that it is possible to realize both accurate modeling and shortening of a time necessary for modeling is led.

According to the present disclosure, an effect that modeling a supporting portion is unnecessary and it is possible to simplify a modeling step is led.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A stereolithography apparatus comprising:
a modeling bath that includes a light transmitting portion on a bottom surface and that stores a photocurable resin and a liquid release material that has a specific gravity larger than that of the photocurable resin and that phase-separates from the photocurable resin;
an optical illuminator that applies light that causes the photosensitive resin that is adjusted into a given thickness to cure via the light transmitting portion;
a platform that is opposed to an interface between the release material and the photocurable resin and that is capable of lifting or lowering with respect to the interface; and
an interface level position adjustment mechanism that adjusts a position of a level of the interface according to a variation in an amount of the release material stored in the modeling bath.

2. The stereolithography apparatus according to claim 1, wherein a side of the light transmitting portion opposed to the release material is formed into a curved shape having a given optical effect.

3. The stereolithography apparatus according to claim 1, wherein the release material has characteristics that an amount of the light that is transmitted through the release material varies according to the position of the level of the interface,
the stereolithography apparatus further comprises a control device that determines fineness of a cross-sectional shape in a position of a level to be modeled based on design image data that defines a cross-sectional shape in a position of each given level of a modeled object that is modeled by application of the light, and
the interface level position adjustment mechanism adjusts the position of the level of the interface according to the determined fineness.

4. The stereolithography apparatus according to claim 3, wherein the interface level position adjustment mechanism adjusts the position of the level of the interface to a position higher than a given reference level when it is determined that the fineness is high and adjusts the position of the level of the interface to a position lower than the given reference level when it is determined that the fineness is low.

5. The stereolithography apparatus according to claim 3, wherein the platform adjusts a thickness of the photocurable resin to a value smaller than a given reference range when it is determined that the fineness is high and adjusts the thickness to a value higher than the given reference range when it is determined that the fineness is low.

6. The stereolithography apparatus according to claim 1, wherein the stereolithography comprising a stereolithography control device that models a modeled object by emitting light to the photocurable resin that is adjusted to a given thickness on the interface between the photocurable resin and the release material via the release material and sequentially layering hardened layers in which the photocurable resin cures, the stereolithography control device comprising a modeling controller that executes
a step of modeling the first modeled object obtained by layering the hardened layers sequentially downward by application of the light while lifting the platform with respect to the interface and
a step of, after lowering the platform with respect to the interface and sinking at least part of the first modeled object in the release material, modeling the second modeled object obtained by layering the hardened layers sequentially upward by application of the light in a position higher than a lowest surface of the first modeled object while further lowering the platform with respect to the interface.

7. The stereolithography apparatus according to claim 6, wherein the modeling controller models the second modeled object from a surface of the first modeled object that is positioned on a side of the platform toward the platform.

8. The stereolithography apparatus according to claim 6, wherein the modeling controller models the second modeled object on a surface of the first modeled object along a height direction.

9. The stereolithography apparatus according to claim 6, wherein the modeling controller executes a step of making a replacement with a photocurable resin of a type different from that of the photocurable resin of the first modeled object after the step of modeling the first modeled object.

10. A method of manufacturing a modeled object using a stereolithography apparatus that includes a modeling bath that stores a photocurable resin and a liquid release material that has a specific gravity larger than that of the photocurable resin and that phase-separates from the photocurable resin and a platform capable of lifting or lowering with respect to an interface between the release material and the photocurable resin and that models a modeled object by emitting light to the photocurable resin that is adjusted to a given thickness on the interface between the photocurable resin and the release material via the release material and sequentially layering hardened layers in which the photocurable resin cures, the method comprising:
modeling the first modeled object obtained by layering the hardened layers sequentially downward by application of the light while lifting the platform with respect to the interface and
after lowering the platform with respect to the interface and sinking at least part of the first modeled object in the release material, modeling the second modeled object obtained by layering the hardened layers sequentially upward by application of the light in a position higher than a lowest surface of the first modeled object while further lowering the platform with respect to the interface.

11. A method of manufacturing a modeled object comprising
storing a photocurable resin and a liquid release material that has a specific gravity larger than that of the photocurable resin and that phase-separates from the photocurable resin in a modeling bath that includes an light transmitting portion on a bottom surface;
applying light that causes the photosensitive resin that is adjusted into a given thickness to cure via the light transmitting portion;
opposed to an interface between the release material and the photocurable resin and that is capable of lifting or lowering with respect to the interface; and
adjusts a position of a level of the interface according to a variation in an amount of the release material stored in the modeling bath.
